(19) United States
(12) Patent Application Publication
(10) Pub. No.: US 2026/0034846 A1
(43) Pub. Date: Feb. 5, 2026

(54) METHOD FOR CONTROLLING THE PRESSURE OF AN AIR BELLOWS

(71) Applicant: ZF CV Systems Europe BV, Brussels (BE)

(72) Inventor: Daniel Wetzel, Lehrte (DE)

(21) Appl. No.: 19/358,202

(22) Filed: Oct. 14, 2025

Related U.S. Application Data
(63) Continuation of application No. PCT/EP2024/059033, filed on Apr. 3, 2024.

(30) Foreign Application Priority Data
Apr. 14, 2023 (DE) 10 2023 109 476.9

(51) Int. Cl. B60G 17/018; B60G 17/052

(52) U.S. Cl. CPC B60G 17/018; B60G 17/0528; B60G 2400/252; B60G 2400/51222

(57) ABSTRACT

A method is for regulating the pressure of an air bellows belonging to an air suspension, a determination of a filling pressure generatable inside the bellows by a filling process takes place with a learning algorithm as well as via a pressure and a height measuring sensor. The pressure sensor is arranged in a feed line leading to the bellows. Before opening the valve, in successive cyclic pressure and height measurements and on the basis of a characteristic curve, in which a characteristic number as a variable representative of a bellows volume V is plotted against the bellows height, a flow rate at the bellows inlet is ascertained and an air mass flow in the line between the valve and the bellows is ascertained therefrom, integrated and added to the bellows air mass. A new filling pressure is ascertained via the algorithm.

### CROSS-REFERENCE TO RELATED APPLICATIONS

This application is a continuation application of international patent application PCT/EP2024/059033, filed Apr. 3, 2024, designating the United States and claiming priority from German application 10 2023 109 476.9, filed Apr. 14, 2023, and the entire content of both applications is incorporated herein by reference.

### TECHNICAL FIELD

The disclosure relates to a method for regulating the pressure of an air bellows belonging to a pressure-regulated air suspension, wherein the determination of a filling pressure that can be generated by a filling process or a pressure that results from a venting process inside the air bellows takes place with the aid of a learning algorithm programmed in a computing device as well as via a pressure measuring sensor and a height measuring sensor, the computing device being assigned to a control device for controlling the switching processes and valves in the air suspension. The disclosure further relates to a device for regulating the pressure of at least one air bellows belonging to a pressure-regulated air suspension by the method according to the disclosure, to a leveling apparatus having such a device, to a control device for use in such a leveling apparatus and to a vehicle having a device according to the disclosure.

### BACKGROUND

Air-spring systems in vehicles represent a significant improvement for driving comfort and for safety. The structure, cargo and in particular passengers of a vehicle are protected by the air springs against shocks that are due to uneven surfaces when driving. Further, vibrations can be damped or even prevented. It is also possible to adapt to road features or different level heights. Adjustable level-regulated air-spring systems are now usual in most commercial vehicles.

In electronically operating air-spring regulating apparatuses/level regulators, the regulation of the pressure in air springs takes place as a function inter alia of a height between the suspension, or axle, on the one hand and the chassis or vehicle frame on the other hand. For this purpose, height measurements are conventionally carried out with the aid of sensors, the sensors being arranged either between the suspension and the chassis or alternatively in the air springs. Direct measurements of a distance from the road surface are also possible. A pressure in a compressed-air line system, and particularly in the air spring, is likewise measured in order to be able to carry out for example regulation of the driving level, ramp height regulation when loading and unloading, overload protection or a kneeling function in case of buses, by filling or venting the individual air springs.

A leveling apparatus is connected via internal communication lines of the vehicle, for instance a CAN bus, or alternatively wirelessly to other vehicle devices and can implement the respectively most favorable control strategy for the individual driving situations with the aid of a computer unit. The associated regulating device, or control unit, of the level regulator for this purpose controls the corresponding valves and operating devices for the air springs.

In such electronically controlled air suspensions (ECAS), integration of component parts and a modular configuration are becoming increasingly popular so as to minimize further component parts, lines and transmission paths in view of the proliferating electronics in the vehicle.

For this reason, there are for example of electronically controlled air suspension concepts (ECAS SPA, Smart Pneumatic Actuator) in which an expensive special pressure sensor in the air bellows is replaced with a pressure sensor directly next to an upstream valve block. Sometimes, however, this has the effect that a pressure measured during an actuation of the valve at the valve block differs not insignificantly from the pressure inside the air bellows. Because of the mass flow or the inertia of the pressurizing medium being delivered, the pressure equilibration takes some time, depending on the line length between the valve block and the air bellows. The pressure prevailing in the air bellows at the instant of the measurement thus does not correspond to the pressure measured at the valve block. There is consequently an offset, that is, a difference between the pressure measured at the sensor and the pressure in the bellows, which is equilibrated only after a certain period of time.

However, the associated computation unit in the regulating device, or control unit, of the level regulation processes the instantaneous pressure signal of the pressure at the valve as an input variable in the scope of the control strategy. The control strategy is aimed at regulating the bellows pressure. The bellows pressure is the controlled variable to be varied purposely toward a setpoint value. As soon as this controlled variable, that is, the bellows pressure, has reached its setpoint value, a filling process is for example stopped and the valve is closed. If—because of the pressure sensor being arranged at the upstream valve block—the measurement of the setpoint value of the controlled variable, which is required therefor, differs from the pressure actually existing in the air bellows, this may cause undesired oscillations or delays in the regulating process. This is the case in particular when, during filling, the pressure measured at the valve is higher than the actual bellows pressure and the valve is therefore initially closed again. This would cause repeated opening and closing of the valve, and possibly to fluttering of the valve.

### SUMMARY

It is an object of the disclosure to provide a method for regulating the pressure of an air bellows belonging to a pressure-regulated air suspension, in which a relatively expensive pressure measurement inside an air bellows can be obviated but the pressure in an air bellows can nevertheless be determined reliably.

This object is achieved via various embodiments of the disclosure.

The pressure measuring sensor required for the method is arranged at a distance from the air bellows in a feed line leading to the air bellows, through which an air mass flow can be delivered under pressure into the air bellows. The air bellows is thus located at the end of the feed line. Provided in the feed line, namely at the start of the feed line, there is a valve which can be switched between a shut-off setting and an open setting for filling or venting the air bellows. The pressure measuring sensor is arranged directly next to the valve at the start of the feed line to the air bellows and measures the pressure existing in the feed line directly at the valve.

For such an arrangement, according to the disclosure, before the valve is opened in order to fill the air bellows,
a) a first measurement of a first pressure p₀ takes place at the pressure measuring sensor, and
b) a first measurement of a current first height h₀ of the air bellows by height measuring sensor takes place, and
c) on the basis of a characteristic curve determined by predefined starting values, in which a dimensionless characteristic number K_{V} as a variable representative of a bellows volume V is plotted against the height of the air bellows, a determination of an assumed starting air mass m₀ in the air bellows takes place with the first pressure p₀, the first height h₀ and with a characteristic number K_{V0} obtained for the first height h₀ from the characteristic curve as a variable representative of a bellows volume V₀, with the aid of the ideal gas law.
   The valve is subsequently opened in order to fill the air bellows and then, while the valve is open, the following steps are respectively carried out in a number of successive cycles within cycle times of the cycles,
d) a measurement of a further pressure p₁ takes place at the pressure measuring sensor,
e) from the difference between the pressure p₁ measured in step d) and the pressure p₀ measured in step a), a flow rate of the air at the bellows inlet corresponding to the pressure difference (p₁−p₀) being ascertained with the aid of the algorithm and an air mass flow m in the feed line between the valve and the air bellows being ascertained therefrom.
f) Subsequently integrating the air mass flow \dot{m} ascertained in step e) over a cycle time to give a differential air mass and adding to the assumed starting air mass m₀ in the air bellows, which was determined in step c), to give a bellows air mass m_{B} assumed after the cycle time, so that

$${m}_{B} = {m}_{0} + \int \dot{m} dt$$

g) Subsequently further measurement of a current height h1 of the air bellows by the height measuring sensor and with the aid of the algorithm ascertaining a new filling pressure p_{B} to be assumed in the air bellows and resulting from the air mass feed during the preceding cycle, according to the formula for the ideal gas law, from a characteristic number K_{V1} ascertained for the height h₁ with the aid of the characteristic curve as a variable representative of a bellows volume V₁ and the bellows air mass m_{B} totaled in step f).
h) Steps d) to g) are repeated within each further individual cycle time, the totaled bellows air mass m_{B} respectively ascertained in the preceding cycle being used as the basis in step f) as a new starting air mass m₀=m_{B} respectively contained in the air bellows.

The new filling pressure p_{B} respectively ascertained in the steps d) to h) is provided as an input signal of an electronic regulating device for filling the air bellows, the valve being closed by the regulating device, and the filling process being ended, after a predefined target pressure in the air bellows is reached.

The characteristic curve introduced here, in which a (dimensionless) characteristic number K_{V} as a variable representative of a bellows volume V is plotted against the height of the air bellows, or the height of the air spring, constitutes a dependency between the bellows volume and the height of the air bellows taking the entire pneumatic system into account, which is unknown in the prior art in this form and use. For this reason, the term “characteristic curve” will be used without further additional terms. If for instance the term “bellows characteristic curve” or “air spring characteristic curve” were to be used, there would be a risk of confusion with for example spring characteristic curves known in the prior art in the form of force-deflection diagrams. This is intended to be avoided here.

With the method according to the disclosure, it is possible to determine an air pressure in an air bellows with the aid of a sensor arranged remotely from the air bellows, that is, without the need to arrange a pressure measuring sensor directly inside the air bellows. Not only does this simplify its configuration, or the configuration of the associated components such as the cover or piston, but also further cablings or connections between the pressure measuring sensor and the control device, or computing device, are rendered superfluous.

Using the method according to the disclosure prevents continual switching of the valve provided for filling the air bellows, that is, constant opening and closing. Unstable regulation is thus avoided. The valve is not closed until a bellows pressure that corresponds to the setpoint value for the filling pressure is ascertained by the method according to the disclosure. For the regulation, the method according to the disclosure provides the bellows pressure, that is, the pressure that actually prevails inside the air bellows, rather than the pressure that exists at the remotely lying measurement location (pressure sensor). Oscillation of the valve, or of the regulation, is therefore avoided.

Here, the bellows volume refers to the volume contained in the bellows. When considering the entire pneumatic system of an air spring, however, the problem arises that both the actually existing bellows volume as well as the dynamic behaviors and the properties of the pneumatic system can scarcely be determined deterministically a priori. The properties are influenced by many parameters, for instance configuration fundamentals and material properties of the air bellows, line diameters and lengths, flow losses et cetera, to name but a few.

Regulation of such a system is therefore conventionally carried out with the aid of measurements in which sensors measure the changes of the system parameters at particular points and provide them as input signals of a control unit. The regulation then generates a change in the system parameters at the measurement points as and when required, which is in turn detected by the sensors.

In the prior art, the measurement of the controlled variable has hitherto been carried out directly at the site of the regulation, so that it keeps to the air spring pressure, by measuring the pressure directly in the air bellows. A computation unit is provided in the control unit so that, with the aid of algorithms, it is possible to regulate or control predetermined sequences which then modify the pressure in the air bellows (site of the regulation).

The pressure in the air bellows depends on the axle load, as does the level to be adjusted, that is, the distance already mentioned above between the suspension or axle, on the one hand, and the chassis/body or vehicle frame on the other hand. For vehicles with more than two axles, the axle loads may be adjusted actively by adapting the bellows pressures.

Here, the concept of the disclosure comes into play, which uses per se known physical relations between pressure, mass and volume as a basis for a control method adapted to an air-spring system, which on the basis of characteristic numbers as representatives of physical variables creates a learning system in which an algorithm provides an input variable for the regulation by progressive adaptation of the characteristic numbers and their approximation to the parameters of a pneumatic system.

Because the adaptation of the characteristic numbers as representative variables to the real variables is approximated to the real values via repeated new measurements, and these are checked again, the pressure in the air bellows (bellows pressure) that is required as a parameter and controlled variable can sufficiently reliably be determined with the method according to the disclosure and used for the regulation.

Although a number of mathematical calculations are therefore required in order to carry out individual method steps, the method according to the disclosure does not focus on calculations per se, but on a sequence of technical steps and calculations for determining the pressure in a pneumatic apparatus particularly configured therefor.

For example, the starting air mass m₀ contained in the air bellows is ascertained in step c) with the aid of the predefined algorithm by using the formulae of the ideal gas law, here

$${p}_{0} \cdot {V}_{0} = {m}_{0} \cdot R \cdot T$$

with
   m₀=starting air mass,
      R: gas constant

$$( {R}_{a i r} = 287.1 \frac{J}{kgK} ) ,$$

T: temperature,
where the characteristic number K_{V0} is to be used as a variable representative of a bellows volume V₀, so that

$${K}_{V 0} {=}^{def} {V}_{0} .$$

The characteristic curve determined by predefined starting values (starting characteristic curve) is first arbitrarily assumed by establishing two characteristic numbers K_{V} as variables representative of a bellows volume. The characteristic numbers are each assigned to a height of the air bellows, or air spring height, and constitute two points on a characteristic curve, namely positive values, the second of which is higher than the first and is assigned to a greater air spring height than the first. The characteristic curve thus reflects a real system in which a characteristic number K_{V} as a variable representative of a bellows volume V is plotted against the height of the air bellows.

The air mass flow t in the feed line between the valve and the air bellows, which is ascertained in step e), may be found with the aid of the predefined algorithm by using the Bernoulli equation, here by using

$$ρ \cdot g \cdot h + \frac{1}{2} \cdot ρ \cdot {v}^{2} + p = const .$$

with
   ρ: density,
   g: acceleration due to gravity,
   h: height,
   v: velocity,
   p: pressure.

For air bellows in vehicle suspensions, when considering a line cross section in the vicinity of a sensor and a line cross section at the inlet to air bellows in the steady state, this equation may be simplified as follows:

$${p}_{sensor} = {p}_{bellows} + \frac{ρ \cdot {v}_{bellows}^{2}}{2}$$

A velocity of the air fed at the inlet to the air bellows is computed therefrom as

$$v = \sqrt{2 \cdot \frac{{p}_{s e n s o r} - {p}_{b e l l o w s}}{ρ}}$$

With the density of the flowing air and the line cross section A, the associated mass flow is given as

$$\dot{m} = v \cdot {ρ}_{bellows} \cdot A .$$

The method according to the disclosure is carried out by using an algorithm which is programmed in a computing device of the control device of a level regulating apparatus (or: leveling apparatus). If such a control device is installed as a subassembly in a level regulating apparatus of an air-suspended vehicle and is combined with the other devices such as valves, lines, switches et cetera, the configuration of the lines, or of the line cross sections is generally unknown, or not stored as a parameter in the computing device. Such an outlay would be high, cost-intensive and time-consuming, and is therefore generally not employed.

In an embodiment of the method, this problem is addressed by a predefined diameter norm of the feed line, preferably a diameter norm of 1, being used in the method according to the disclosure as the basis for ascertaining the air mass flow in step e). The specification of such a diameter norm is unproblematic and merely entails a modified scaling of the characteristic curve which is required for determining the actual bellows pressure.

The pressure existing in the bellows is defined by the air mass in the air bellows and the volume of the air bellows. This relationship is described in the ideal gas law, as mentioned above. With a characteristic number K_{V1} ascertained for the height h₁ with the aid of the characteristic curve as a variable representative of a bellows volume V₁ and the bellows air mass m_{B} totaled in step f)

$${m}_{B} = {m}_{0} + \int \dot{m} d t ,$$

a new filling pressure p_{B} to be assumed in the air bellows and resulting from the air mass feed during the preceding cycle is ascertained with the aid of the algorithm, namely again with the ideal gas law, so that

$${p}_{B} = \frac{{m}_{B} \cdot {R}_{a i r} \cdot T}{{V}_{b e l l o w s}}$$

If the bellows volume V_{bellows} is now set equal to V₁, a value of the pressure in the bellows, that is, of the controlled variable, may be provided with the aid of the method according to the disclosure without separate pressure sensors being required in the bellows. Once the required controlled variable is reached, namely the required pressure level in the bellows, the regulation or the control device may close the valve for filling the bellows.

In a further embodiment of the method, the cycle times for carrying out all of steps d) to g) while the valve is open are 25 ms. Other cycle times are also possible, for example cycle times of 20 ms, although it has been found with the particularly known cycle time of 25 ms that the method according to the disclosure then already leads to a sufficiently approximated determination of the pressure in the air bellows.

In another embodiment of the method, a further measurement of a pressure pₒₚₜ at the pressure measuring sensor and a further measurement of a height hₒₚₜ of the air spring take place following a filling process, a characteristic number Kₒₚₜ corresponding to the measurement values pₒₚₜ and hₒₚₜ being ascertained with the bellows air mass in the air bellows ascertained after the previous filling process, the pressure pₒₚₜ and the height hₒₚₜ, and being entered into the characteristic curve as a learned representative variable, that is, introduced in place of the height hₒₚₜ. The subscript “opt” here stands for “optimized”, which reflects the learning ability of system.

This relativizes an original inaccuracy due to the fact that the flow velocity, calculated with the aid of the Bernoulli equation, of the air between the sensor and the bellows inlet is applicable only for incompressible fluids. The equation does not take into account losses that result because of the flow resistance in the line. Yet since the method according to the disclosure provides a learning algorithm, and according to the disclosure the ascertained values are gradually approximated to the actual values for the mass flow and the bellows pressure by a respectively following with the aid of pressure measurements during the closure time of the valve, verified and used as a basis for the corrected characteristic curve, in the course of time this approach is highly suitable for providing the ECAS system with a bellows pressure that is sufficiently accurate for the regulation.

Another embodiment of the method consists in a characteristic number Kₒₚₜ as a variable representative of the air spring volume being ascertained at the earliest 400 ms after the valve is closed. Such a configuration allows “learning”, or an optimization of the characteristic curve, to take place only after a certain transient response, or after a settling time or pressure equilibration time after the valve closure. Only after this settling time of at least 400 ms following the closing of the valve is the pressure in the bellows interior and the feed line, which by then has become equilibrated, measured with the pressure sensor at the valve block. The pressure then measured thus corresponds accurately to the pressure existing in the bellows.

The settling time, however, relates only to ascertaining the characteristic number Kₒₚₜ belonging to the height hₒₚₜ for further use when subsequently ascertaining the pressure. But if it should be necessary to open the valve again before the settling time has elapsed, it is not yet possible to have “learned” a “new” characteristic number Kₒₚₜ.

In a further embodiment of the method, the learned characteristic number Kₒₚₜ belonging to the height hₒₚₜ for the bellows volume is used as the basis for ascertaining the starting mass m₀ in step a) during a fresh valve opening. The learned, newly ascertained characteristic number Kₒₚₜ thus becomes the starting value for determining the pressure/activating the valve and carrying out the method according to the disclosure again. The algorithm hence “learns” the new characteristic curve values uses them as a basis in the future.

During the valve actuations and the associated filling of the bellows, the bellows dimensions are modified. The instantaneous height is measured with the height sensor at control positions. Since a characteristic curve is initially assumed and the actual characteristic curve is unknown, it is determined by calculating back to the volume that was required for the last fill in order to reach the present bellows pressure. For this operation, the bellows pressure measured after closing the valve is used. Following the pressure equilibration after closing the valve, this is the actual bellows pressure and may be used to optimize the characteristic curve. As mentioned above, the characteristic curve is therefore adapted and the method according to the disclosure for determining the pressure can increasingly take the actual vehicle conditions into account.

For a new vehicle, the pressure determination may be started with an assumed characteristic curve that consists of only two points saved by way example and provisionally for the height and volume.

In order to be able to use an acceptably valid characteristic curve as quickly as possible as the basis for subsequent ascertainments of the bellows pressure according to the disclosure, another embodiment of the method consists in the characteristic curve being adapted by extrapolating the characteristic number Kₒₚₜ respectively ascertained for the highest measured height hₒₚₜ of the air spring as the ordinate value to the end of the height values plotted on the abscissa.

According to an embodiment of the method for regulating the pressure of the support and lift bellows of a lift axle belonging to a pressure-regulated air suspension, in method steps c) and g) during the raising or lowering of the lift axle, both for the support bellows assigned to the lift axle and for the lift bellows a constant characteristic number K_{V-lift} as a variable representative of a constant bellows volume V is plotted against the height of the air bellows and is assumed for the entire inflation process. Since a height measurement is not possible on the lift axle during the raising or lowering, the method steps may be performed here with the additional assumption of a constant bellows volume. In this way, the method according to the disclosure may also be used for the bellows of a lift axle.

In a slightly modified embodiment, the method according to the disclosure may also be used for the venting. According to an embodiment of the method for regulating the pressure of an air bellows belonging to a pressure-regulated air suspension, in which the determination of a pressure resulting from a venting process inside the air bellows takes place with the aid of a learning algorithm programmed in an associated computing device as well as via a pressure measuring sensor and a height measuring sensor, before the valve is opened in order to vent the air bellows,
a) a first measurement of a first pressure p₀ takes place at the pressure measuring sensor, and
b) a first measurement of a current first height h₀ of the air bellows by height measuring sensor takes place, and
c) on the basis of a characteristic curve determined by predefined starting values, in which a dimensionless characteristic number K_{V} as a variable representative of a bellows volume V is plotted against a height of the air bellows, a determination of an assumed starting air mass m₀ in the air bellows takes place with the first pressure p₀, the first height h₀ and with a characteristic number K_{V0} obtained for the first height h₀ from the characteristic curve as a variable representative of a bellows volume V₀.

The valve is subsequently opened in order to vent the air bellows and then, while the valve is open, respectively in a number of successive cycles within cycle times of the cycles,
d) a measurement of a further pressure p₁ takes place at the pressure measuring sensor,
e) from the difference between the pressure p₀ measured in step d) and the pressure p₁ measured in step a), a flow rate of the air at the bellows outlet corresponding to the pressure difference (p₀−p₁) being ascertained with the aid of the algorithm and an air mass flow m in the line/feed line between the air bellows and the valve being ascertained therefrom by using the Bernoulli equation, the air mass flow being multiplied by a correction factor kᵥₑₙₜ that takes into account the friction loss in the line, after which
f) the air mass flow m ascertained in step e) and provided with the correction factor is integrated over a cycle time to give a differential air mass and subtracted from the assumed starting air mass m₀ in the air bellows, which was determined in step c), to give a bellows air mass m_{B} assumed after the cycle time, so that

$${m}_{B} = {m}_{0} - \int \dot{m} dt .$$

g) A further measurement of a current height h1 of the air bellows by the height measuring sensor takes place and a new filling pressure p_{B} to be assumed in the air bellows and resulting from the air mass discharge during the preceding cycle is ascertained (ideal gas law) with the aid of the algorithm from a characteristic number K_{V1} ascertained for the height h₁ with the aid of the characteristic curve as a variable representative of a bellows volume V₁ and the bellows air mass m_{B} ascertained in step f).
h) Steps d) to g) are repeated within each further individual cycle time, the ascertained bellows air mass m_{B} respectively ascertained in the preceding cycle being used as the basis in step f) as a new starting air mass m₀=m_{B} respectively contained in the air bellows.

The new filling pressure p_{B}, or venting pressure, respectively ascertained in the steps d) to h) is provided as an input signal of an electronic regulating device for venting the air bellows, the valve being closed by the regulating device, and the venting process being ended, after a predefined target pressure/venting pressure in the air bellows is reached.

The correction factor kᵥₑₙₜ addresses the fact that the pressure measured at the pressure sensor during the venting is already affected by friction. This is not the case during inflation, since the friction losses in the line to the air bellows do not occur in the flow considered there until behind the pressure sensor.

According to another embodiment of the method for regulating the pressure during the venting, the air mass flow is multiplied by a correction factor kᵥₑₙₜ=1 as an initial value, that is, at the beginning of the pressure regulation.

In a device for regulating the pressure of an air bellows belonging to a pressure-regulated air suspension by the method according to the disclosure, in which the air bellows is filled or vented via a leveling apparatus, the leveling apparatus has an associated control device for controlling the switching processes and valves as well as a computing device assigned to the control device with a programmed learning algorithm. The leveling apparatus furthermore has a pressure measuring sensor for measuring the bellows pressure according to the disclosure, as well as a height measuring sensor assigned to each air bellows. The pressure measuring sensor for measuring the air bellows pressure is arranged at a valve arranged in a feed line to the air bellows and at a distance from the air bellows, in particular at a valve block located at the start of the feed line, an air mass flow being deliverable under pressure in the feed line into the air bellows or from the air bellows, and the valve block having directional control valves which can be switched to a shut-off setting, an inflation setting and a venting setting in order to fill or vent the air bellows via the feed line. The pressure measuring sensor is arranged at the valve outlet which leads to the feed line to the air bellows.

For the structural configuration of electronically controlled air suspensions (ECAS SPA), this gives a compact configuration in particular for the combination of the valve block and the pressure sensors, which leads to very favorable production since separate pressure sensors in the air bellows may be replaced with a pressure sensor directly next to the valve block.

Such a device for regulating the pressure of the air bellows belonging to the air suspension is advantageous in a leveling apparatus of a commercial vehicle with air suspension, particularly in a truck or a commercial vehicle trailer. The same applies to a control device for use in such a leveling apparatus, the control device being assigned a computing device in which a learning algorithm for carrying out the method according to the disclosure is programmed.

As already mentioned, such a device operating by the method according to the disclosure is suitable for all types of air-suspended vehicles, and in particular for air-suspended light trucks or commercial vehicle trailers, for which it is important that all components of electronically controlled air suspension can be offered in such a way as to be as compact, easy to install and economical as possible.

### BRIEF DESCRIPTION OF DRAWINGS

The invention will now be described with reference to the drawings wherein:

FIG. 1 shows with the aid of a diagram an equivalent model on which the method according to the disclosure is based;

FIG. 2 shows a schematic diagram of the essential elements of a device for carrying out the method according to the disclosure;

FIG. 3 shows a characteristic curve assumed at the beginning of the ascertainment by the method according to the disclosure;

FIG. 4 shows a characteristic curve obtained after a plurality of filling and venting processes and approximated to the real conditions by the method according to the disclosure;

FIG. 5 shows a comparison of the characteristic curves according to FIGS. 3 and 4; and,

FIG. 6 shows a block diagram to illustrate individual method steps.

### DETAILED DESCRIPTION

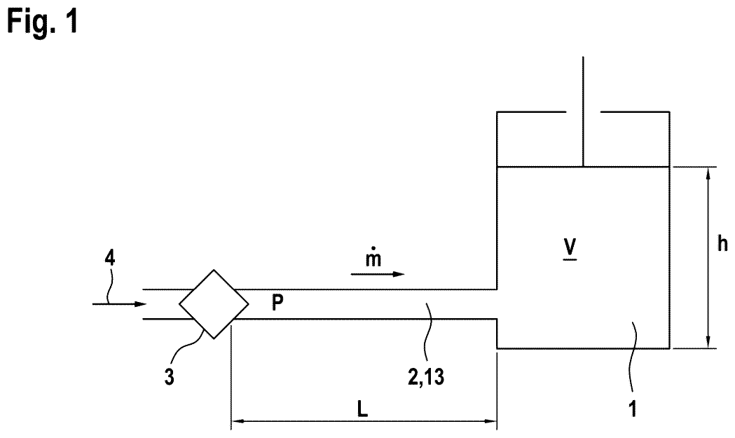

FIG. 1 shows with the aid of a diagram an equivalent model, on which the method according to the disclosure is based, for determining a filling pressure that can be generated by a filling process. It shows a stylized air bellows 1, replaced by a piston-cylinder model, having an associated feed line 2 and a pressure measuring sensor 3. During filling, an air mass flow t is created in the feed line 2. The air, or air quantity or air mass, 4 necessary for the filling is delivered from a pressure source (not represented in detail), that is, from a compressor or from a pressure accumulator, via a valve into the feed line 2. At the start of the feed line 2, that is, separated from the air bellows 1 by the feed line length L, the medium pressure/air pressure existing in the feed line 2 is measured with the aid of the pressure measuring sensor 3. The height h corresponds to the height of the air bellows as measured by a height measuring sensor, and the volume V contained in the piston-cylinder model corresponds to the air spring volume.

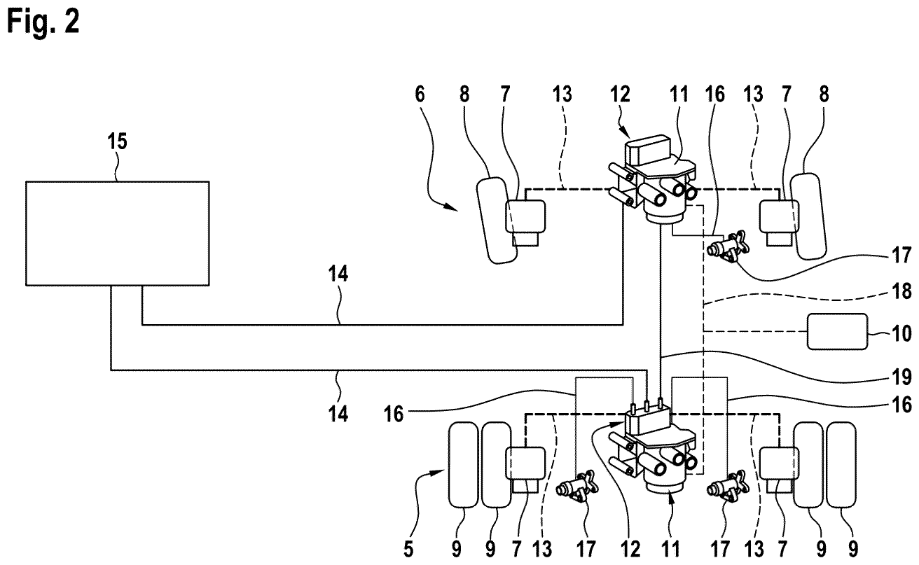

FIG. 2 shows in the form of a schematic diagram essential elements of a device for carrying out the method according to the disclosure, such as are arranged and required for a pressure-regulated air suspension in a commercial vehicle with a driven rear axle 5 and a non-driven front axle 6. The rear axle 5 and the front axle 6 are represented merely symbolically in FIG. 2 by the arrangement of air springs/air bellows 7 as well as by a single tire on the front axle with the tires 8 and by twin tires on the driven rear axle with the tires 9.

The supply pressure for the air bellows 7, or air springs, is generated by a compressor (not represented in detail) that fills a pressure accumulator 10 via which the individual air springs 7 can also be supplied with air.

In order to regulate the filling, and therefore to regulate the air suspension, a leveling apparatus is provided, which has inter alia solenoid valves, namely switchable valves 11 with the respectively associated electromagnetic actuation devices 12. The supply lines, or feed lines 13, from the solenoid valves 11, 12 to the air bellows 7 are also shown. The valves 11 are configured as directional control valves, and can be switched to a shut-off setting, an inflation setting and a venting setting in order to fill or vent the respective air bellows 7 via the feed lines 13.

There are also data lines 14 to a control device 15 of the leveling apparatus, as well as a data line 19 between the electronic circuits provided at the valves 11, 12. The data line 19 subserves the communication between the valves as well as between the valves and the control device 15. Further data lines 16 connect the height measuring sensors 17 to the control device 15 by using electronic circuits at the valves.

Compressed-air supply pressure lines 18 are furthermore represented, which are connected to the feed lines 13 via the switchable solenoid valves 11, 12 so that the air springs/air bellows 7 can be filled or vented.

The switchable solenoid valves 11, 12 may be arranged in a valve block in which a plurality of different valves of the control loop are combined. The electromagnetic actuation devices 12, the valves 11 and the electronic component parts provided at the valves are respectively fitted together in a compact housing.

By using the control device 15, the valves 11, 12 are switched while taking into account the signals of the height measuring sensors 17 and of the pressure sensors (not represented separately here) within the valve block. The control device 15 contains an associated computing device with a programmed learning algorithm.

The pressure measuring sensors are located at the outlets of the valves 11, 12 to the feed lines 13 and are thus arranged at a distance from the respective air bellows 7, at the start of the associated feed line 13. For the sake of clarity, the pressure measuring sensors have not been represented in detail in FIG. 2.

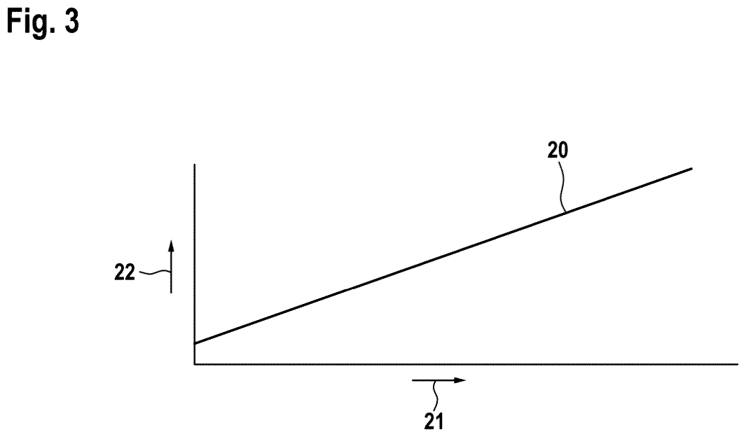

The filling of an air bellows with the leveling apparatus then takes place by the method according to the disclosure with initial use of a characteristic curve for an air bellows, as is represented in FIG. 3.

FIG. 3 shows the characteristic curve 20 assumed at the beginning of the ascertainment by the method according to the disclosure, namely the ratio of the height of the air bellows 21 to the characteristic number 22 for the bellows volume. The characteristic curve is predefined by two characteristic curve points/curve points, which are not represented in detail here.

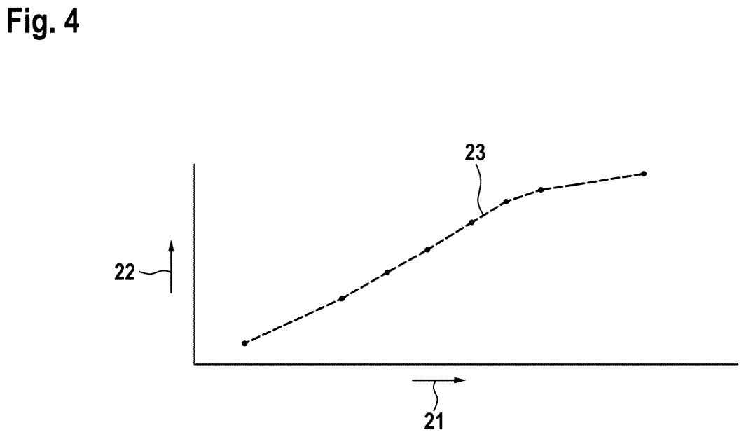

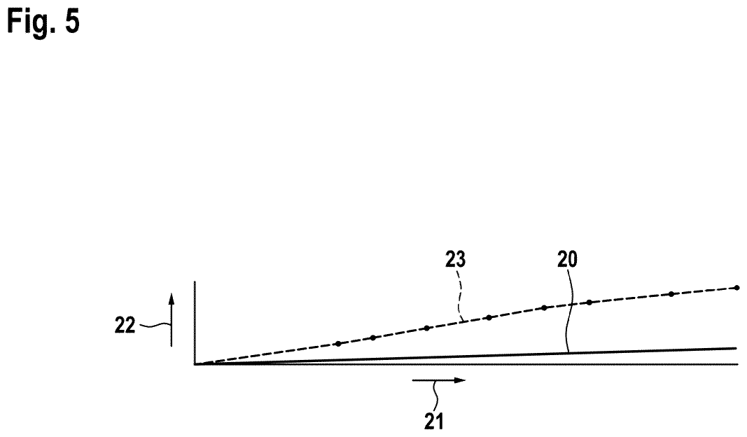

FIGS. 4 and 5 also show characteristic curves, which indicate the ratio of the height of the air bellows 21 to the characteristic number 22 for the bellows volume.

FIG. 4 shows a characteristic curve 23 obtained after a plurality of filling and venting processes by the method according to the disclosure and approximated to the real conditions, which is then used as the basis for the further determinations according to the disclosure of the filling pressure in the bellows.

FIG. 5 shows the characteristic curve 20 in comparison with the characteristic curve 23 ultimately obtained by the method according to the disclosure, adapted to the real conditions, the two characteristic curves being represented here on a different scale, however, and over the total working height of the air bellows.

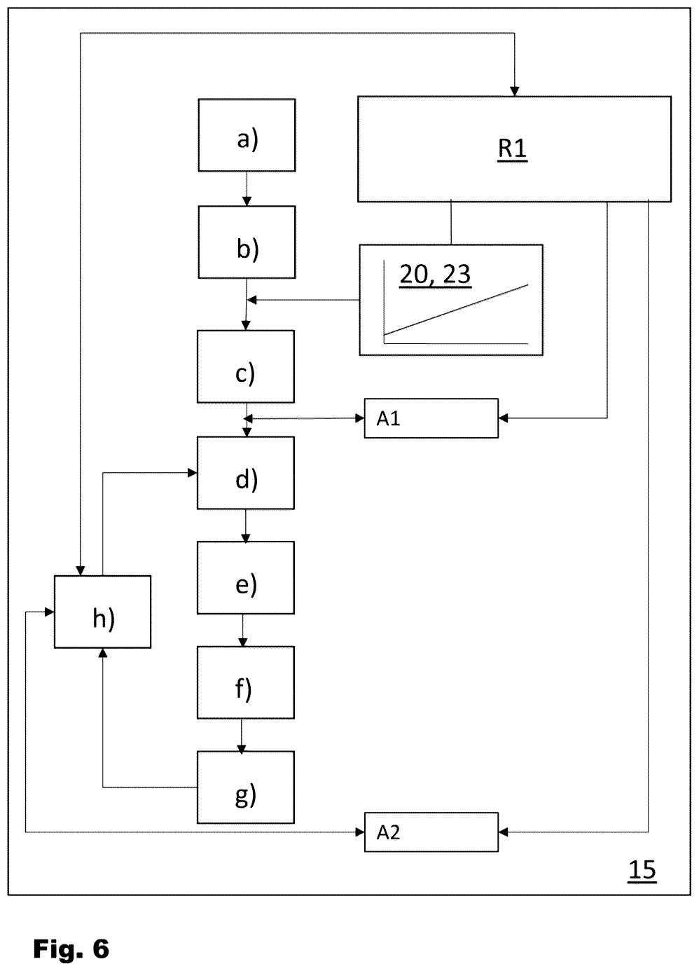

FIG. 6 illustrates once more with the aid of a block diagram the individual method steps a) to h) which are controlled by the algorithm that is programmed in the computing device R1 of the control device 15. The control device, or the algorithm, then also initiates the action A1, that is, the opening of the solenoid valve, as well as the action A2, that is, the closing of the valve. It also indicates the use of characteristic curves 20, 23 as representative variables during the determination of a filling pressure that can be generated inside the air bellows by a filling process.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 air bellows, represented as an element of a piston-cylinder model
2 feed line
3 pressure measuring sensor
4 air quantity
5 rear axle
6 front axle
7 air bellows, air spring
8 tires—single tire
9 tires—twin tires
10 pressure accumulator
11 switchable valve
12 electromagnetic actuation device
13 supply line/feed line
14 data line
15 control device, vehicle controller
16 data line
17 height measuring sensor
18 compressed-air supply line
19 data line
20 starting characteristic curve—ratio of the height of the air bellows to the number characteristic of the bellows volume
21 abscissa of the characteristic curve—height of the air bellows
22 ordinate of the characteristic curve—number characteristic of the bellows volume
23 characteristic curve—ratio of the height of the air bellows to the number characteristic of the bellows volume
h height of the air bellows (in the piston-cylinder model)
V air spring volume (in the piston-cylinder model)
L line length (in the piston-cylinder model)
A1 action: open valve
A2 action: close valve
R1 computing device with programmed algorithm

1. A method for regulating a pressure of an air bellows belonging to a pressure-regulated air suspension, wherein a determination of a filling pressure that can be generated inside the air bellows by a filling process takes place with the aid of a learning algorithm programmed in an associated computing device as well as via a pressure measuring sensor and a height measuring sensor, the computing device being assigned to a control device for controlling switching processes of valves in the air suspension, wherein the pressure measuring sensor is arranged at a distance from the air bellows in a feed line leading to the air bellows through which an air mass flow can be delivered under pressure into the air bellows, wherein a valve, which can be switched between a shut-off setting and an open setting for filling or venting the air bellows, is provided in the feed line and the pressure measuring sensor is arranged between the valve and the air bellows, the method comprising:
before the valve is opened in order to fill the air bellows:
a) taking a first measurement of a first pressure p₀ at the pressure measuring sensor;
b) taking a first measurement of a current first height h₀ of the air bellows by the height measuring sensor;
c) on a basis of a characteristic curve determined by predefined starting values, in which a dimensionless characteristic number K_{V} as a variable representative of a bellows volume V is plotted against a height of the air bellows, determining an assumed starting air mass m₀ in the air bellows with the first pressure p₀, the first height h₀ and with a characteristic number K_{V0} obtained for the first height h₀ from the characteristic curve as a variable representative of a bellows volume V₀;
opening the valve in order to fill the air bellows;
after said opening the valve in order to fill the air bellows, while the valve is open, respectively in a number of successive cycles within cycle times of the cycles:
d) taking a further measurement of a further pressure p₁ at the pressure measuring sensor;
e) from a pressure difference between the pressure p₁ measured in step d) and the pressure p₀ measured in step a), ascertaining a flow rate of air at a bellows inlet corresponding to the pressure difference with the aid of the algorithm and ascertaining the air mass flow in the feed line between the valve and the air bellows therefrom;
f) integrating the air mass flow ascertained in step e) over a cycle time to give a differential air mass and added to the assumed starting air mass m₀ in the air bellows, determined in step c), to give a bellows air mass m_{B} assumed after the cycle time;
g) taking a further height measurement of a current height h₁ of the air bellows by the height measuring sensor and ascertaining a new filling pressure p_{B} to be assumed in the air bellows and resulting from the air mass feed during a preceding cycle with the aid of the algorithm from a characteristic number K_{V1} ascertained for the height h₁ with aid of the characteristic curve as a variable representative of a bellows volume V₁ and the bellows air mass m_{B} totaled in step f);
h) repeating steps d) to g) within each further individual cycle time, the totaled bellows air mass m_{B} respectively ascertained in the preceding cycle being used as the basis in step f) as a new starting air mass m₀=m_{B} respectively contained in the air bellows; and,
wherein the new filling pressure p_{B} respectively ascertained in the steps d) to h) is provided as an input signal of an electronic regulating device for filling the air bellows, the valve being closed by the regulating device, and the determination of the filling pressure for the filling process being ended, after a predefined target pressure in the air bellows is reached.

2. The method of claim 1, wherein the cycle times for carrying out all of steps d) to g) while the valve is open are 25 milliseconds.

3. The method of claim 1, wherein a predefined diameter norm of the feed line is used as the basis for ascertaining the air mass flow in step e).

4. The method of claim 1, wherein the characteristic curve is determined by at least two predefined starting value pairs for the characteristic number K_{V} and the respectively associated height of the air bellows.

5. The method of claim 1, further comprising taking a further measurement of a pressure pₒₚₜ at the pressure measuring sensor and a further measurement of a height hₒₚₜ of the air bellows following the filling of the air bellows; wherein with the bellows air mass m_{B} in the air bellows ascertained after a previous filling process, the pressure pₒₚₜ and the height hₒₚₜ, a characteristic number Kₒₚₜ corresponding to measurement values of the pressure pₒₚₜ and the height hₒₚₜ is ascertained as a variable representative of an optimized bellows volume and is entered into the characteristic curve as a learned characteristic number belonging to the height hₒₚₜ, in place of the former characteristic number contained there.

6. The method of claim 5, wherein the characteristic number Kₒₚₜ is ascertained at the earliest 400 milliseconds after the valve is closed.

7. The method of claim 5, wherein the learned characteristic number Kₒₚₜ belonging to the height hₒₚₜ, as a variable representative of the optimized bellows volume, is used as a basis for ascertaining the starting air mass m₀ in step a) during a fresh valve opening instead of a hitherto existing or ascertained characteristic number as a variable representative of a new bellows volume.

8. The method of claim 5, wherein the characteristic curve is adapted by extrapolating the characteristic number Kₒₚₜ respectively ascertained for the highest measured height hₒₚₜ of the air spring as a variable representative of the optimized bellows volume as an ordinate value to an end of the height values plotted on an abscissa.

9. The method of claim 1 wherein in method steps c) and g) during raising or lowering of a lift axle, both for a support bellows assigned to the lift axle and for a lift bellows, a constant characteristic number K_{V-lift} as a variable representative of the bellows volume V being constant is plotted against the height of the air bellows and is assumed for the entire inflation process.

10. The method of claim 3, wherein the predefined diameter norm is 1.

11. A method for regulating the pressure of an air bellows belonging to a pressure-regulated air suspension, wherein the determination of a pressure resulting from a venting process inside the air bellows takes place with the aid of a learning algorithm programmed in an associated computing device as well as via a pressure measuring sensor and a height measuring sensor, the computing device being assigned to a control device for controlling switching processes of valves in the air suspension, wherein the pressure measuring sensor is arranged at a distance from the air bellows in a feed line leading to the air bellows, through which an air mass flow can be delivered under pressure from the air bellows, wherein a valve, which is configured to be switched between a shut-off setting and an open setting for filling or venting the air bellows, is provided in the feed line and the pressure measuring sensor is arranged between the valve and the air bellows, the method comprising:
before the valve is opened in order to vent the air bellows:
a) taking a first measurement of a first pressure p₀ at the pressure measuring sensor, and
b) taking a first measurement of a current first height h₀ of the air bellows by the height measuring sensor; and,
c) determining, on a basis of a characteristic curve determined by predefined starting values, in which a dimensionless characteristic number K_{V} as a variable representative of a bellows volume V is plotted against a height of the air bellows, an assumed starting air mass m₀ in the air bellows takes place with the first pressure p₀, the first height h₀ and with a characteristic number K_{V0} obtained for the first height h₀ from the characteristic curve as a variable representative of a bellows volume V₀;
opening the valve in order to vent the air bellows;
while the valve is open, respectively in a number of successive cycles within the cycle times:
d) taking a measurement of a further pressure p₁ at the pressure measuring sensor; wherein
e) from the difference between the pressure p₁ measured in step d) and the pressure p₀ measured in step a), ascertaining a flow rate of air at a bellows outlet corresponding to the pressure difference (p₀−p₁) with the aid of the learning algorithm and air mass flow in the feed line between the air bellows and the valve is ascertained therefrom, the air mass flow being multiplied by a correction factor kᵥₑₙₜ that takes into account a friction loss in the feed line;
after which:
f) integrating the air mass flow ascertained in step e) and provided with a correction factor over a cycle time to give a differential air mass and subtracted from the assumed starting air mass m₀ in the air bellows, which was determined in step c), to give a bellows air mass m_{B} assumed after the cycle time;
g) taking a further measurement of a current height h₁ of the air bellows by the height measuring sensor and ascertaining a new filling pressure p_{B} to be assumed in the air bellows and resulting from an air mass discharge during the preceding cycle with the aid of the algorithm from a characteristic number K_{V1} ascertained for the height h₁ with the aid of the characteristic curve as a variable representative of a bellows volume V₁ and the bellows air mass m_{B} ascertained in step f);
h) repeating steps d) to g) within each further individual cycle time, the ascertained bellows air mass m_{B} respectively ascertained in the preceding cycle being used as the basis in step f) as a new starting air mass m₀=m_{B} respectively contained in the air bellows;
wherein the new filling pressure p_{B} respectively ascertained in the steps d) to h) is provided as an input signal of an electronic regulating device for venting the air bellows, the valve being closed by a regulating device, and the determination of the bellows pressure for the venting process being ended, after a predefined target pressure in the air bellows is reached.

12. The method of claim 11, wherein as an initial value the air mass flow is multiplied by a correction factor kᵥₑₙₜ=1.

13. A device for regulating the pressure of at least one air bellows belonging to a pressure-regulated air suspension, wherein a determination of a filling pressure that can be generated inside the air bellows by a filling process takes place with the aid of a programmed learning algorithm, the device comprising:
a control device for controlling switching processes and valves as well as a computing device assigned to the control device with the programmed learning algorithm;
a pressure measuring sensor and a height measuring sensor assigned to the at least one air bellows;
said pressure measuring sensor for measuring the air bellows pressure being arranged at a valve arranged in a feed line to the at least one air bellows and at a distance from the at least one air bellows;
an air mass flow can be delivered under pressure in the feed line into the air bellows or from the air bellows and the valve is configured as a directional control valve and is configured to be switched to a shut-off setting, an inflation setting and a venting setting in order to fill or vent the air bellows via the feed line, wherein the pressure measuring sensor is arranged at a valve outlet of the valve which leads to the feed line to the air bellows.

14. The device of claim 13, wherein a valve block is arranged at a start of the feed line to the air bellows, which lies remotely from the air bellows.

15. A leveling apparatus in a commercial vehicle with air suspension, the leveling apparatus comprising the device of claim 13.

16. The leveling apparatus of claim 15, wherein the commercial vehicle is a truck or a commercial vehicle trailer.

17. A control device for a leveling apparatus in a commercial vehicle with air suspension, the control device comprising the computing device in which the learning algorithm for carrying out the method of claim 1 is programmed.

18. An air-suspended vehicle comprising the device of claim 13.

19. The air-suspended vehicle of claim 17, wherein the vehicle is an air-suspended truck or an air-suspended trailer.
